(19) United States
(12) Patent Application Publication
(10) Pub. No.: US 2005/0266272 A1
(43) Pub. Date: Dec. 1, 2005

(54) Magneto-optical storage medium

(75) Inventor: Gavin Nicholas Phillips, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/527,893

(22) PCT Filed: Aug. 8, 2003
(86) PCT No.: PCT/IB03/03626

§ 371 Date: Mar. 15, 2005

(30) Foreign Application Priority Data
Sep. 18, 2002 (EP) 02078868.3

(51) Int. Cl. G11B 5/66

(52) U.S. Cl. 428/817

(57) ABSTRACT

The invention relates to a magneto-optical storage medium (200) and specifically a domain expansion storage medium. The medium (200) comprises a magnetic storage layer (107) for long term information storage and a thereto magnetically coupled magnetic reproduction or read-out layer (111), wherein an enhanced magnetic domain may be generated during read out. The magnetic layers (107, 111) are separated by a non-metallic or metallic, non-magnetic or magnetic layer (109) and at least one metal layer (201, 203), such as Palladium or Platinum, is located adjacent to the magnetic reproduction layer (111). Preferably this metal layer (201, 203) is located on each side of the magnetic reproduction layer (111). The metal layer(s) (201, 203) provides increased heat dissipation and Kerr effect thereby permitting increased data density of the magneto-optical storage medium (200).

The invention relates to a magneto-optical storage medium and in particular to the AC-MAMMOS (Magnetic Amplifying Magneto-Optical System) type of domain expansion media.

In recent years, the penetration of magneto-optical storage media in the consumer market place has increased significantly. Magneto-optical storage techniques provide the advantages of high data density and fast data reading and writing rates, and therefore provide suitable means for high capacity data storage on a small size medium.

In recent years, a number of new magneto-optical storage techniques, known as domain expansion (DomEx) technology, have been developed in order to obtain increased media data density. The two established forms of DomEx technology are known as MAMMOS (Magnetic Amplifying Magneto-Optical System) and DWDD (Domain Wall Displacement Detection) technologies. MAMMOS media can be divided into two types: AC-MAMMOS and ZF-MAMMOS; during read-back a pulsed (AC) magnetic field is required for the former, while zero applied field (ZF) is required for the latter.

An AC-MAMMOS medium comprises at least two magnetic layers. One magnetic layer is the storage layer (or recording layer) wherein information is stored during writing of the medium. The second magnetic layer is a reproduction layer (also known as a read-out layer). During reading of the information, the reproduction layer is manipulated to create an expanded magnetic domain corresponding to the magnetic domain of the storage layer.

Specifically, data retrieval in AC-MAMMOS typically operates in the following fashion. During an AC-MAMMOS read-out operation, a low power laser spot heats up both the storage and read-out layers. This causes the magnetization of, and stray field from, the storage layer to increase while causing the coercivity of the reproduction layer to decrease. At the same time, a pulsed magnetic field is applied to the medium. When this field is in synchronization with the recorded bit pattern, and when parallel to the stray field from a bit, a domain with the same direction of magnetization as the bit in the storage layer, but opposite magnetization to the pre-magnetized read-out layer, will be nucleated and expand in the reproduction layer.

The expanded domain is large enough to be resolved by optical detection via the Kerr effect, giving a “peak” in the read-out signal. The Kerr effect is the rotation in the polarization of incident laser light on reflection from a magnetic material. The size and sense of the rotation of the polarization is proportional to the magnetization of the magnetic material, and can be monitored by the use of a suitable detector.

Following, the reading of the bit, the expanded domain in the reproduction layer is collapsed by the pulsed field reversing sign. Oppositely magnetized bits are not read out because their magnetization is already aligned with that of the read-out layer, and thus no change in the Kerr signal is observed.

A further description of the AC-MAMMOS technique can be found in, for example, “Magnetooptical Recording Technology Toward 100 Gb/in²” by H. Awano & N. Ohta; IEEE Journal of Selected Topics in Quantum Electronics; 1998; Vol. 4; No. 5 pp 815 to 820.

An important parameter for all both conventional and domain expansion magneto-optical storage media is the Figure Of Merit (FOM) which is approximately equal to the square root of the product of the reflectivity and the sum of the squares of the Kerr rotation angle and ellipticity (FOM=\sqrt{R(θ²+ε²)}, where R is the reflectivity, θ is Kerr rotation and ε is Kerr ellipticity). The FOM is an indication of how strong an optical read out signal may be obtained. In order to increase the data density of magneto-optical storage media, it is desirable to use lower wavelength laser light as this allows for a higher resolution between individual bits. However, for current magneto-optic media, the figure of merit decreases as the laser wavelength is reduced from 660 nm (red) to 410 nm (blue), thus reducing the Carrier to Noise Ratio (CNR) and thereby increasing the error rate. Additionally, the sensitivity of the optical detectors decreases at blue wavelengths, decreasing the CNR even more. This becomes critical at high data rates as the detector averaging times decrease thus reducing the CNR to unacceptably low levels. One option to overcome this is to increase laser read-back power (increase the number of photons reaching the detector), however this requires more careful thermal design of the medium in order to reduce unwanted laser induced heating.

In order to achieve a high data rate media it is therefore an advantage if improved Figure Of Merits can be achieved at lower laser wavelengths as this will allow for higher data densities. Additionally, it would be advantageous to have enhanced heat dissipation for magneto-optical storage media thereby allowing higher power laser light to be used.

Accordingly, the Invention seeks to provide an improved magneto-optical medium alleviating or mitigating one or more of the above disadvantages singly or in combination.

Accordingly there is provided a magneto-optical recording medium comprising:
a substrate layer for supporting other layers;
a magnetic storage layer for information storage;
a magnetic reproduction layer for reproduction of the information of the magnetic storage layer for reading of the information;
a separation layer inter-located between the magnetic storage layer and the magnetic reproduction layer; and
at least one metal layer adjacent to the magnetic reproduction layer.

The additional metal layer provides increased heat dissipation characteristics as well as an increased Kerr effect and thus increased Figure Of Merit (FOM). Further, the additional metal layer may cause an increase in reflectivity thereby coupling more light into the detectors on reflection from the reproduction layer and thus enhancing the FOM further. The increased FOM and heat dissipation allows for the use of higher power and lower wavelength lasers thereby enabling an increased data density for the medium.

The separation layer located between the storage and reproduction layers may for example be non-metallic or metallic, non-magnetic (e.g. in the case of AC-MAMMOS media) or magnetic (e.g. in the case of ZF-MAMMOS and DWDD media). Additionally the separation layer may consist of a single layer or a number of layers.

According to a first feature of the invention one of the at least one metal layers is inter-located between the storage layer and the reproduction layer. This provides the advantage of increased heat dissipation, reflectivity and improved Kerr effect.

According to a second feature of the invention one of the at least one metal layers is adjacent the reproduction layer in the opposite direction of the magnetic storage layer. Similarly this provides for the advantage of increased heat dissipation, reflectivity and Kerr effect.

According to a third feature of the invention the magneto-optical storage medium comprises two metal layers adjacent to the magnetic reproduction layer on each side of the magnetic reproduction layer. The heat dissipation, reflectivity and increased Kerr effect is augmented by placing a metal layer on both sides of the reproduction layer.

According to a fourth feature of the invention, the magneto-optical storage medium further comprises a reflection layer inter-located between the substrate and the storage layer. This reflection layer provides for increased reflection and coupling of light into the storage and reproduction layers. The layer may further assist in the heat dissipation from the writing or reading focus.

According to a fifth feature of the invention, the reflection layer is located on the substrate layer; a first dielectric layer is located on the reflection layer; the magnetic storage layer is located on the first dielectric layer; the separation layer is located on the magnetic storage layer; the metal layer is located on the separation layer; the magnetic reproduction layer is located on the metal layer; a second dielectric layer is located on the magnetic reproduction layer; and a cover layer is located on the second dielectric layer. This provides for a highly efficient magneto-optical storage medium with high data density. It specifically provides for a magneto-optical storage medium, which can be dimensioned to have suitable mechanical, thermal, magnetic and optical characteristics to allow high data density storage.

According to a sixth feature of the invention, the reflection layer is located on the substrate layer; a first dielectric layer is located on the reflection layer; the magnetic storage layer is located on the first dielectric layer; the separation layer is located on the magnetic storage layer; the magnetic reproduction layer is located on the separation layer; the metal layer is located on the magnetic reproduction layer; a second dielectric layer is located on the metal layer, and a cover layer is located on the second dielectric layer. This provides for a highly efficient magneto-optical storage medium with high data density. It specifically provides for a magneto-optical storage medium, which can be dimensioned to have suitable mechanical, thermal, magnetic and optical characteristics to allow high data density storage.

According to a seventh feature of the invention, the reflection layer is located on the substrate layer; a first dielectric layer is located on the reflection layer; the magnetic storage layer is located on the first dielectric layer; the separation layer is located on the magnetic storage layer; a first metal layer of two metal layers is located on the separation layer; the magnetic reproduction layer is located on the first metal layer; a second metal layer of two metal layers is located on the magnetic reproduction layer; a second dielectric layer is located on the second metal layer, and a cover layer is located on the second dielectric layer.

According to an eighth feature of the invention, the metal of the at least one metal layer comprises a transition metal. The metal may thus be a transition metal, or an alloy containing a transition metal. Specifically, a thin layer containing one of these metals allows for more heat to be conducted through the layer and for an increased reflectivity.

According to a ninth feature of the invention, the metal of the at least one metal layer comprises metal chosen from the group consisting of Pt, Pd, Ta, Zr, Nb, Mo, Ru, Rh, Cu, Ag, Au and W. Specifically, these materials provide for one or few atomic layers of the metal adjoining the reproduction layer to enhance the Kerr effect and thus further improve the FOM.

According to a tenth feature of the invention, the at least one metal layer has a thickness of less than 2 nm. Hence, preferably very thin layers are used thereby not significantly degrading the magnetic coupling between the storage layer and the reproduction layer or the optical or mechanical characteristics and also providing the increased heat dissipation, reflectivity and Kerr effect.

According to an eleventh feature of the invention, the separation layer is a dielectric layer. This provides for a suitable layer for controlling the optical characteristics of the layer stack of the magneto-optical storage medium.

According to a twelfth feature of the invention the at least one metal layer is coupled to the magnetic reproduction layer such that the at least one metal layer cause an increased Kerr rotation. This provides the advantage of allowing for an increased FOM thereby allowing increased data density of the magneto-optical storage medium.

According to a thirteenth feature of the invention, the at least one metal layer is coupled to the magnetic reproduction layer such that the at least one metal layer cause an increased heat dissipation. This allows for increased laser powers to be used thereby enabling higher data densities of the magneto-optical storage medium. Additionally, the layer preferably provides an increased Kerr effect and thus improved FOM.

According to a fourteenth feature of the invention, the at least one metal layer is coupled to the magnetic reproduction layer such that the at least one metal layer cause an increased reflectivity. This provides the advantage of increasing the coupling of light into the reproduction layer thereby improving the FOM and thus enabling higher data densities.

According to a fifteenth feature of the invention, the magneto-optical recording medium is a domain expansion medium, such as a Magnetic Amplifying Magneto-Optical System (MAMMOS) medium, or Domain Wall Displacement Detection (DWDD) medium.

These and other aspects of the invention will be apparent from and elucidated with reference to the embodiments described hereinafter.

An embodiment of the invention will be described, by way of example only, with reference to the drawings, in which

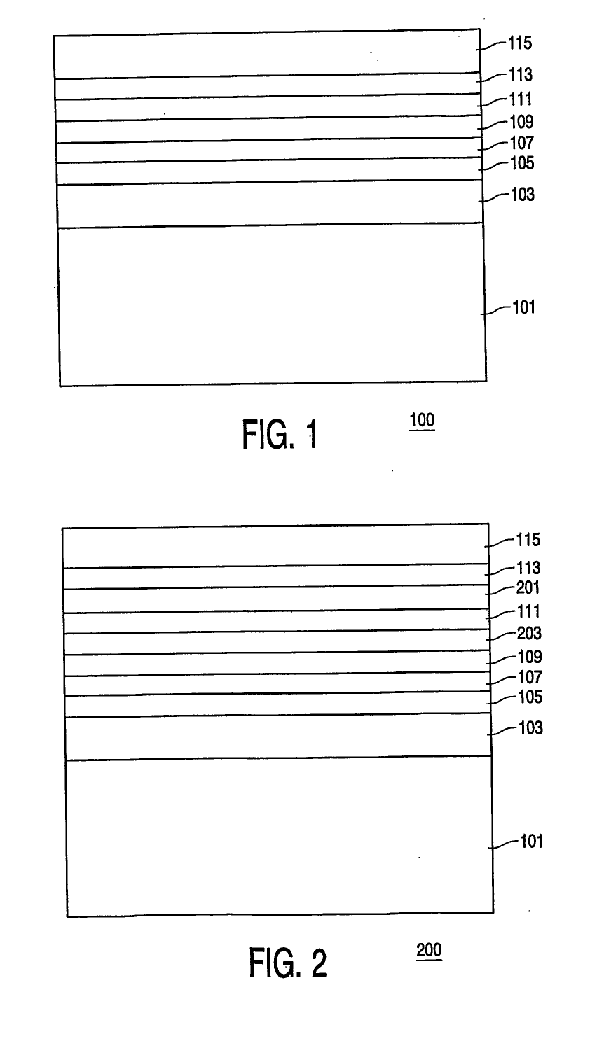

FIG. 1 is an illustration of a typical MAMMOS medium; and

FIG. 2 illustrates a magneto-optical medium in accordance with an embodiment of the invention

In the following, a preferred embodiment of the invention will be described but it will be apparent that the invention is not limited to this application. Specifically, the preferred embodiment of the application to AC-MAMMOS media is described, however this invention is equally applicable to all domain expansion media, including for example ZF-MAMMOS and DWDD media.

FIG. 1 is an illustration of a typical MAMMOS medium 100.

The illustrated medium comprises a substrate 101 made out of a polycarbonate medium. The substrate provides the mechanical basis for the remaining layers. On top of the substrate is placed a reflective and heat conductive layer 103. This layer performs the dual function of acting as a light reflector during reading and writing operations as well as assisting in the dissipation of heat generated by the laser during these operations. The reflective heat conducting layer 103 is in the preferred embodiment deposited directly on top of the substrates and is made up of a thin Aluminium Chromium film (AlCr).

On top of the reflective heat conductive layer 103 is a dielectric layer 105 which is used to control the optical characteristics of the layer stack such that as much light as possible is coupled to the storage and reproduction layers. The reflective layer is in the preferred embodiment a Si₃N₄ (Silicon Nitride) layer.

On top of the dielectric layer 105 is a magnetically hard TbFeCo (Terbium Iron Cobalt) storage layer 107. The storage layer 107 is where the information is stored in magnetically stable and semi-permanent domains. The size of each domain or bit is very small and in the order of 20 to 100 nm in length resulting in a high density of the information on the disc. Typically, data densities of up to 20 Gbit/in² are currently attainable, and this figure is expected to rise significantly in the following years. The storage layer is very thin and typically on the order of 20 nm.

The storage layer 107 is followed by another dielectric layer 109 made from a Si₃N₄ material, and on top of this dielectric layer 109 is the reproduction layer 111, which is magnetostatically coupled to the storage layer 107, and assists in the reading operation by providing an expanded magnetic domain facilitating optical detection. The reproduction layer 111 is in the preferred embodiment made from magnetically soft GdFeCo (Gadolinium Iron Cobalt) material. The reproduction layer thus requires lower magnetic field strength than the storage layer to create a magnetic domain.

On top of the reproduction layer 111 is a third dielectric layer 113 and on top of this layer is a cover layer made out of acrylic resin providing mechanical protection to the underlying layers.

Data storage for the described medium can be achieved by using a thermo-magnetic writing technique. Specifically, the storage layer is heated to the Curie temperature by a focussed laser spot, and then allowed to cool in the presence of a magnetic field. The magnetization of the heated area is then “frozen” with an orientation parallel to that of the magnetic field. The direction of the magnetic field applied during the cooling phase is controlled by the data value of the data bit to be stored. In this way, a magnetic domain is created with a magnetic field orientation corresponding to the data value of the bit.

Reading from the storage medium 100 is achieved by a MAMMOS process wherein the domain in the recording layer is enlarged in the reproduction layer under the control of a low power heating laser and a magnetic field. The magnetic field direction of the enlarged domain of the reproduction layer is optically read by detecting the impact of the magnetization on the Kerr rotation of incident laser light.

In order to improve performance, the magneto-optical disc of FIG. 1 is modified by incorporation of metal layers adjacent to the reproduction layer. Hence, preferably a layer of metal is situated directly below and/or above the reproduction layer.

Thus, FIG. 2 illustrates a magneto-optical medium in accordance with an embodiment of the invention.

In the preferred embodiment, the magneto-optical medium thus comprises the same layers as described for FIG. 1 with the addition of one or two additional metal layers which are placed immediately adjacent to the reproduction layer. Thus the metal layers are located directly adjacent to the reproduction layer and specifically in direct contact with reproduction layer.

Hence, as illustrated, the magneto-optical medium 200 in accordance with the preferred embodiment comprises the cover layer 115 next to the dielectric layer 113 which again is next to a first metal layer 201. The first metal layer 201 is directly next to the reproduction layer 111, which again is in contact with a second metal layer 203. The remaining layers are identical to the medium of FIG. 1 and thus comprise a dielectric layer 109 next to the second metal layer 203. Then follows the storage layer 107 with the storage layer 107 being next to another dielectric layer 105, which again is adjacent to the reflective heat conductive layer 103 on the substrate 101.

By placing metal layers next to the reproduction layer, a number of advantages can be achieved. Specifically, the metal layers provide additional heat distribution and thus act as additional heat sinks in addition to the heat distribution achieved from the reflective heat conductive layer 103. This allows for higher read-back laser powers to be employed thereby allowing a greater Carrier to Noise Ratio (CNR).

Additionally, the introduction of additional metal layers results in an increase in the Kerr rotation and ellipticity at shorter wavelengths. It is expected that at least for the case of Pt and Pd, the increased Kerr effect is caused in part by the first few atomic layers of the metal layer becoming magnetically polarized when placed adjacent to the magnetic material of the reproduction layer. The enhanced Kerr effect results in a stronger variation in the optical read-out signal. Hence, an enhanced Figure Of Merit (FOM) is obtained with increased CNR and thus fewer errors are generated for the same laser wavelength and power.

Consequently, the decrease in FOM at reduced wavelengths is compensated by the increased laser power and increased Kerr effect thereby allowing lower laser wavelengths to be used. Thus, acceptable error performance can be achieved for blue lasers (approximately 405 nm). This allows for smaller domains to be resolved by the optical detection and thus provides for increased data density of the magneto-optical storage medium.

Preferably, the magneto-optical medium comprises a metal layer on each side of the reproduction layer but in other embodiments, only one of these metal layers may be included. Hence, specifically only the metal layer located above the reproduction layer on the opposite side to the storage layer may be included. This provides for increased reflectivity for incident light as well as increased heat conductivity.

The metal layers are preferably comprised of transition metals as these metal layers are thought have the most suitable mechanical, optical and thermal characteristics. Specifically, it is preferred that the metal layers are made of Palladium (Pd) and/or Platinum (Pt). These metals have the additional advantage that when placed next to a magnetic material, the top few atomic layers may exhibit a magnetic polarization whereby the Kerr effect is enhanced at shorter wavelengths.

Preferably, the metal layers are thin and preferably, the thickness of each metal layer is less than two nm. This provides for a suitable heat conductivity and Kerr effect enhancement while not significantly adding to the total thickness of the medium or affecting the magnetic coupling between the storage and reproduction layer.

Furthermore, for a metal layer thickness of this size, the metal layer will increase reflection of the read-back radiation from the reproduction layer. This reduces the likelihood that the read-back laser light reaches the storage layer and is absorbed or reflected by this layer. Thus, the possibility of unwanted “ghost” read-back signals from the storage layer (a kind of “print-through” effect) may also be reduced.

In the preferred embodiment, a dielectric layer 109 is deposited between the storage layer and reproduction layer. However, a separation layer having other characteristics may be used in other embodiments. Thus, although a dielectric layer provides for a suitable control of the optical characteristics of the medium, other materials may be used and specifically separation layers may for example be made out of metals or other magnetic or non-magnetic materials.

In different embodiments, the separator layer can be magnetic or non-magnetic separation layer. Specifically, for AC-MAMMOS media, a non-magnetic separator is preferred. For DWDD media the separator is preferred to be magnetic and may e.g. consist of up to three laminations with different compositions. For ZF-MAMMOS media, the separator preferably consists of both non-magnetic and magnetic laminations.

It will be understood that modifications may be made to the preferred embodiment herein described, and specifically that some of the described layers may be omitted from the medium, other not described layers may possibly be included or a different order of the described layers may be implemented. However, the medium will comprise at least a magnetic storage layer and a magnetic reproduction layer with a separation layer located somewhere in between the two magnetic layers and at least one metal layer adjacent to the magnetic reproduction layer.

It will be understood that any suitable method of manufacturing of the magneto-optical medium may be used. The person skilled in the art will be aware of a number of suitable manufacturing methods but preferably, the magneto-optical medium is manufactured as a magneto-optical disc with a polycarbonate substrate and the remaining layers individually sputter deposited in subsequent steps.

Although the present invention has been described in connection with the preferred embodiment, it is not intended to be limited to the specific form set forth herein. Rather, the scope of the present invention is limited only by the accompanying claims.

1. A magneto-optical recording medium comprising:
a substrate layer for supporting other layers;
a magnetic storage layer for information storage;
a magnetic reproduction layer for reproduction of the information of the magnetic storage layer for reading of the information;
a separation layer inter-located between the magnetic storage layer and the magnetic reproduction layer; and
at least one metal layer adjacent to the magnetic reproduction layer.

2. A magneto-optical recording medium as claimed in claim 1 wherein one of the at least one metal layers is inter-located between the storage layer and the reproduction layer.

3. A magneto-optical recording medium as claimed in claim 1 wherein one of the at least one metal layers is adjacent the reproduction layer in the opposite direction of the magnetic storage layer.

4. A magneto-optical recording medium as claimed in claim 1 wherein the magneto optical storage medium comprises two metal layers adjacent to the magnetic reproduction layer on each side of the magnetic reproduction layer.

5. A magneto-optical recording medium as claimed in claim 1 further comprising a reflection layer inter-located between the substrate and the storage layer.

6. A magneto-optical recording medium as claimed in claim 5 wherein:
the reflection layer is located on the substrate layer;
a first dielectric layer is located on the reflection layer;
the magnetic storage layer is located on the first dielectric layer;
the separation layer is located on the magnetic storage layer;
the metal layer is located on the separation layer;
the magnetic reproduction layer is located on the metal layer;
a second dielectric layer is located on the magnetic reproduction layer; and
a cover layer is located on the second dielectric layer.

7. A magneto-optical recording medium as claimed in claim 5 wherein:
the reflection layer is located on the substrate layer;
a first dielectric layer is located on the reflection layer;
the magnetic storage layer is located on the first dielectric layer;
the separation layer is located on the magnetic storage layer;
the magnetic reproduction layer is located on the separation layer;
the metal layer layers is located on the magnetic reproduction layer;
a second dielectric layer is located on the metal layer; and
a cover layer is located on the second dielectric layer.

8. A magneto-optical recording medium as claimed in claim 5 wherein:
the reflection layer is located on the substrate layer;
a first dielectric layer is located on the reflection layer;
the magnetic storage layer is located on the first dielectric layer;
the separation layer is located on the magnetic storage layer;
a first metal layer of the two metal layers is located on the separation layer;
the magnetic reproduction layer is located on the first metal layer;
a second metal layer of the two metal layers is located on the magnetic reproduction layer;
a second dielectric layer is located on the second metal layer; and
a cover layer is located on the second dielectric layer.

9. A magneto-optical recording medium as claimed in claim 1 wherein the metal of the at least one metal layer comprises a transition metal.

10. A magneto-optical recording medium as claimed in claim 9 wherein the metal of the at least one metal layer comprises metal chosen from the group consisting of:
a. Platinum
b. Palladium
c. Tantallum
d. Zircomium
e. Neobium
f. Molybdenum
g. Ruthenium
h. Rhodium
i. Copper
j. Silver
k. Gold; and
l. Tungsten.

11. A magneto-optical recording medium as claimed in claim 1 wherein the at least one metal layer has a thickness of less than 2 nm.

12. A magneto-optical recording medium as claimed in claim 1 wherein the separation layer is a dielectric layer.

13. A magneto-optical recording medium as claimed in claim 1 wherein the at least one metal layer is coupled to the magnetic reproduction layer such that the at least one metal layer cause an increased Kerr rotation.

14. A magneto-optical recording medium as claimed in claim 1 wherein the at least one metal layer is coupled to the magnetic reproduction layer such that the at least one metal layer cause an increased heat dissipation.

15. A magneto-optical recording medium as claimed in claim 1 wherein the at least one metal layer is coupled to the magnetic reproduction layer such that the at least one metal layer cause an increased reflectivity.

16. A magneto-optical recording medium as claimed in claim 1 wherein the magneto-optical recording medium is a domain expansion medium.

17. A magneto-optical recording medium as claimed in claim 1 wherein the magneto-optical recording medium is a Magnetic Amplifying Magneto-Optical System (MAMMOS) medium.

18. A magneto-optical recording medium as claimed in claim 17 wherein the magneto-optical recording medium is an AC MAMMOS medium.

19. A magneto-optical recording medium as claimed in claim 17 wherein the magneto-optical recording medium is a ZF MAMMOS medium.

20. A magneto-optical recording medium as claimed in claim 16 wherein the magneto-optical recording medium is a Domain Wall Displacement Detection (DWDD) medium.
